(19) United States
(12) Patent Application Publication
(10) Pub. No.: US 2002/0116270 A1
(43) Pub. Date: Aug. 22, 2002

(54) Voice response certificate redemption system

(76) Inventor: Lowell Potiker, Rancho Santa Fe, CA (US)

Correspondence Address: Bernard L. Kleinke, Foley & Lardner, 23 rd Floor, 402 West Broadway, San Diego, CA, 92101-3542, US

(21) Appl. No.: 10/081,715

(22) Filed: Feb. 20, 2002

Related U.S. Application Data
(60) Provisional application No. 60/270,934, filed on Feb. 22, 2001.

(51) Int. Cl. G06F 17/60

(52) U.S. Cl. 705/14; 705/27

(57) ABSTRACT

A method and system are disclosed, and include issuing and redeeming a certificate over a network in conjunction with an interactive voice response system. Information is received relating to a certificate the user is purchasing over the network. The certificate is created based on the received information, including the name of the merchant at which the certificate can be redeemed and a certificate identifier. The certificate is transmitted to the user over the network. Merchant identification is received in response to a call from a caller to the interactive voice response system to redeem the certificate. Merchant identification is validated. The interactive voice response system is instructed to request the caller to enter the certificate identifier if the merchant identification is valid. The certificate identifier entered by the caller is received over the network, and the certificate is validated based on the received certificate identifier.

This application claims priority under 35 U.S.C. §119(e) to provisional U.S. Application No. 60/270,934 filed on Feb. 22, 2001.

### FIELD OF THE INVENTION

The invention relates generally to electronic certificates and, more particularly, to a system and method using voice response redemption of electronic certificates.

### BACKGROUND OF THE INVENTION

Retail stores of any kind, such as department stores or restaurants, typically allow customers to purchase certificates for themselves or to give as a gift. The certificate may be purchased for any desired amount by the customer. The certificates may be used by the purchaser of the certificate or by one who receives the certificate as a gift to purchase items at the applicable retail store up to the amount purchased by the customer. To purchase the certificate, the customer typically travels to the retail store and arranges for the purchase of the certificate with an employee of the retail store. Because of the face to face nature of the purchase of the certificate, the retail store can ensure the integrity and accuracy of the issued certificate and effectively verify its integrity when a customer comes to redeem the certificate.

With the advent of the Internet, retails stores have created an online presence that enables customers to review items being sold by the stores, as well as to purchase items from those stores. In addition to reviewing and purchasing items, a customer may also purchase a certificate that may be redeemed at the retail store. In contrast to the face to face purchase of the certificate, the purchase of the certificate over the Internet does not have the same integrity or accuracy, making it more difficult to verify the integrity of the certificate when a customer attempts to redeem it. Accordingly, it would be useful to have a system for effectively verifying the redemption of online-purchased certificates.

### BRIEF DESCRIPTION OF THE DRAWINGS

FIG. 1 is a block diagram of a system for generating electronic certificates consistent with the present invention.

FIG. 2 is a schematic illustration of a system for the redemption of the electronic certificates consistent with the present invention.

FIG. 3 is a flowchart illustrating the purchase of an electronic certificate by a consumer consistent with the present invention.

FIGS. 4A-4B are flowcharts illustrating the operation of the voice response redemption system consistent with the present invention.

### DETAILED DESCRIPITION OF SPECIFIC EMBODIMENTS

A method and system are disclosed, and include issuing and redeeming a certificate over a network in conjunction with an interactive voice response system. Information is received relating to a certificate the user is purchasing over the network. The certificate is created based on the received information, including the name of the merchant at which the certificate can be redeemed and a certificate identifier. The certificate is transmitted to the user over the network. Merchant identification is received in response to a call from a caller to the interactive voice response system to redeem the certificate. Merchant identification is validated. The interactive voice response system is instructed to request the caller to enter the certificate identifier if the merchant identification is valid. The certificate identifier entered by the caller is received over the network, and the certificate is validated based on the received certificate identifier.

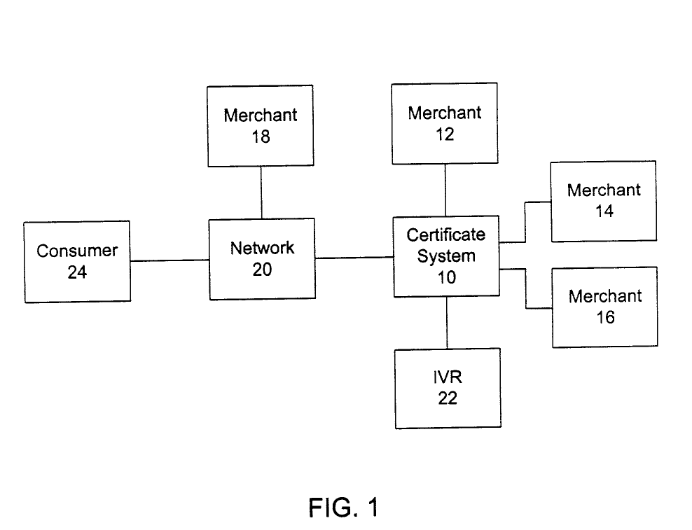

FIG. 1 is a block diagram of a system for generating electronic certificates consistent with the present invention. As shown in FIG. 1, a certificate system 10 is made accessible to a plurality of merchants 12, 14, 16 and 18. The merchants 12, 14, 16 and 18 may be retail stores, restaurants or other types of businesses at which customers may purchase items. The merchants may be given access to the certificate system 10 either directly, as illustrated by merchants 12, 14 and 16, or through a public network 20, such as the internet or a public switched telephone network (PSTN). As illustrated in FIG. 1, merchant 18 accesses the certificate system 10 through the public network 20. The merchants may access the system in order to offer electronic certificates to a plurality of consumers through the certificate system 10. For example, the merchants may post gift certificates or special purchase offers to sell to consumers on the certificate system 10.

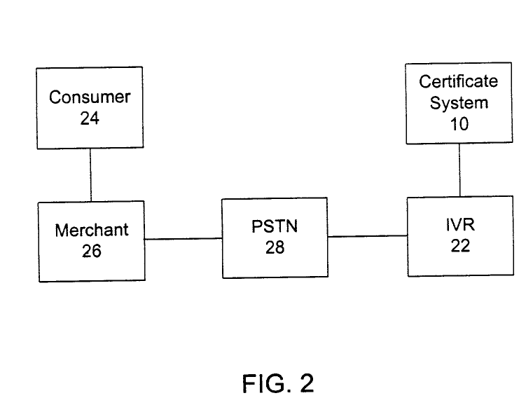

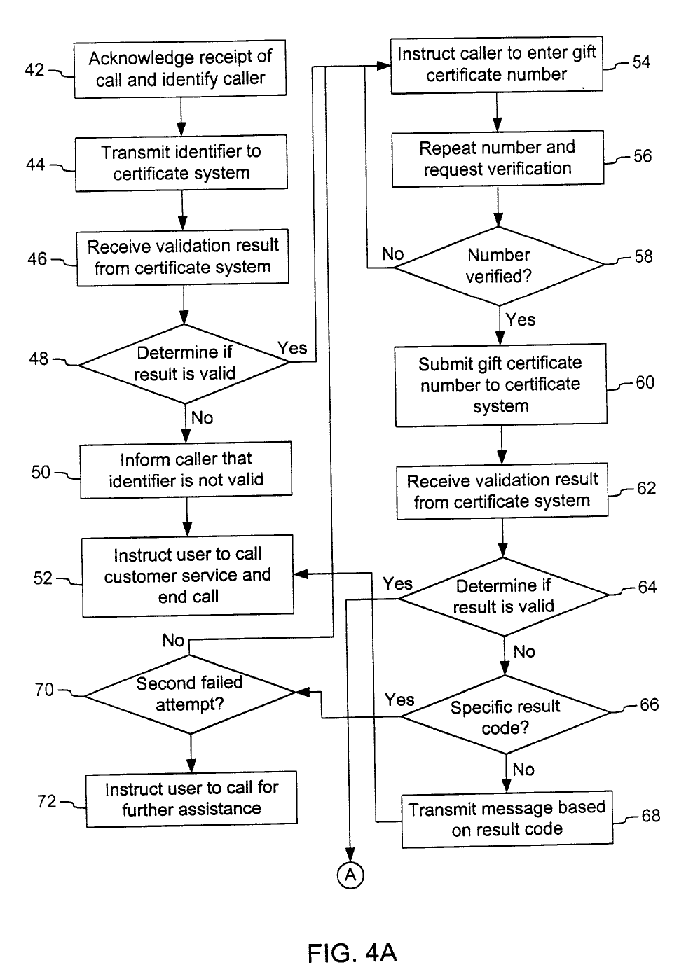

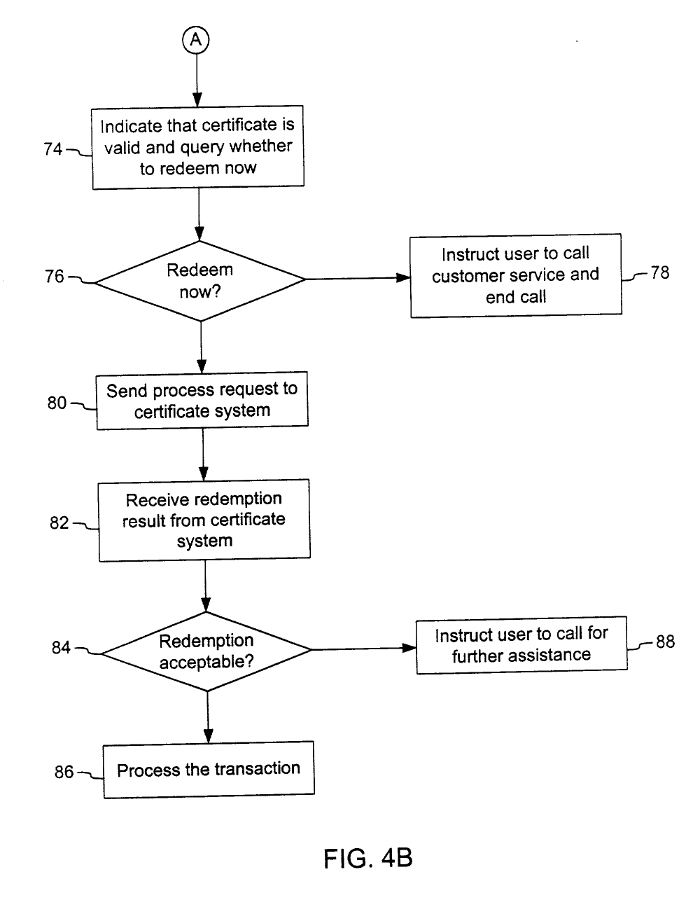

The certificate system 10 may comprise one or more servers, such as the commonly available Apache server. The certificate system 10 may also comprise a database containing information regarding the merchants and their posted offerings. As discussed below, the database may also contain information regarding the purchases made by the consumers. The certificate system 10 can operate in conjunction with an interactive voice response system (IVR) 22. The IVR 22 will be described in further detail below with reference to FIGS. 2, 4A and 4B. The IVR 22 may be an integral component of the certificate system 10 located at the same place or be a separate component coupled together by a communication link, such as through a network or other form of data line.

A consumer 24 may connect to the certificate system 10 via the public network 20 discussed above (e.g., internet or PSTN). The consumer 24 may purchase the offerings of the merchants through the certificate system 10 by, for example, connecting to the certificate system 10 through the internet or calling through the PSTN. Once the consumer 24 completes the purchase of the certificate offered by the merchants, the consumer 24 receives a certificate from the merchant. The certificate may be, for example, in the form of a graphic file containing the certificate information. The format of the certificate may be established by the owner of the certificate system 10 or by the merchant for marketing purposes. In one embodiment, the graphic file is sent to the consumer through electronic mail for printing by the consumer at his computer. Alternatively, either a document with certificate-related information or the certificate itself may be mailed to the consumer through standard mail.

The certificate received by the consumer 24 includes information such as the certificate number, the name of the purchaser, the name of the merchant, and any parameters related to the purchase of the certificate, such as the amount of the certificate. It may also include conditions imposed on the redemption of the certificate. Such conditions may include the time, the days and the purchases to which the certificate may be applied.

FIG. 2 is a schematic illustration of a system for the redemption of the electronic certificates consistent with the present invention. Once a consumer 24 has purchased the certificate and has obtained either a paper certificate or the relevant information for the certificate, the consumer 24 may redeem the certificate with a merchant 26. As part of the redemption, the consumer 24 presents the certificate to the merchant 26, and the merchant 26 accesses the IVR 22 through the PSTN 28.

The consumer 24 may present the certificate to the merchant 26 in one of several ways. For example, the consumer may visit the merchant's physical outlet or visit a merchant's website. The merchant's access to the IVR 22 may be accomplished through a standard telephone system. In one embodiment, the merchant accesses the IVR 22 via a touch-tone telephone. The IVR 22 is connected to the certificate system 10, as described above with reference to FIG. 1. In particular, the IVR 22 is capable of accessing a database within the certificate system 10. The database may include information relevant to the merchant and the information in the purchased certificate being presented, such as the certificate number, the name of the purchaser, the name of the merchant, any parameters related to the purchase of the certificate, and any conditions to the redemption of the certificate.

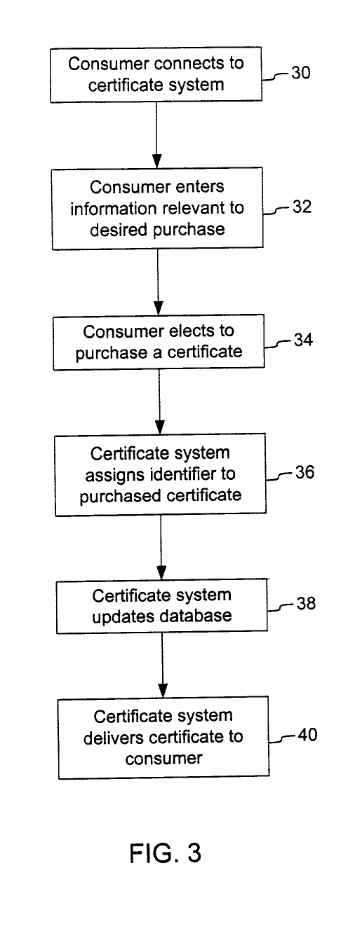

FIG. 3 is a flowchart illustrating the purchase of an electronic certificate by a consumer consistent with the present invention. As shown in FIG. 3, a consumer 24 connects to the certificate system 10 (step 30). The consumer 24 can connect to the certificate system 10 via a public network 20 such as the internet or PSTN 28, as described above in FIG. 1. Once connected to the certificate system 10 , the consumer 24 enters information relevant to the certificate which the consumer 24 desires to purchase (step 32). The information may include, for example, the name of the merchant and the value of the certificate, as well as any other information the consumer 24 may want in the certificate, such as a message for a gift. The consumer 24 then elects to purchase the specified certificate (step 34). The purchase may be completed by selecting a method of payment such as a credit card or electronic cash.

The certificate system 10 assigns an identifier to the purchased certificate. The identifier may be specified by the consumer 24, the certificate system 10, or may be a combination of consumer-provided information and a code determined by the certificate system 10. For example, the identifier may include a 4-digit code specified by the consumer 24, appended to a code determined by the certificate system 10 based on the nature of the certificate.

The certificate system 10 then updates its database (step 38). The update may include updating the particular merchant's account and appending a list of valid certificate identifiers to include the purchased certificate. The update may also include storing information about the certificate including the name of the purchaser, any parameters related to the purchase of the certificate, such as the amount of the certificate, and any conditions to the redemption of the certificate, such as limitations on when the certificate can be redeemed. In addition to updating the database, the certificate system 10 delivers the certificate to the consumer 24 (step 40). As described above, the certificate may be delivered as a graphic file by e-mail, or as a paper document delivered by standard mail.

FIGS. 4A-4B are flowcharts illustrating the operation of the voice response redemption system consistent with the present invention. When the consumer 24 presents the certificate to the merchant 26, the merchant 26 places a telephone call to the certificate system 10 via the IVR 22. The certificate system 10 acknowledges the telephone call from the merchant 26 and signals the IVR 22 to instruct the merchant 26 to wait while the certificate system 10 verifies the merchant's identity (step 42). Such identification can be made through the use of standard toll-free phone number systems. The 800-number system, for example, allows the recipient of a phone call to identify the telephone number of the caller automatically. Alternatively, the IVR 22 may request the merchant 26 to supply an identification number via, for example, the touch tone pad of the telephone. The merchant 26 enters the merchant ID, which is transmitted to the IVR 22.

The IVR 22 transmits the merchant ID to the certificate system 10 for verification (step 44). The certificate system 10 validates the merchant ID, and the IVR 22 receives the result of the validation from the certificate system (step 46). The result may be in the form of a one-character flag, such as an S (safe) or an F (fail). The certificate system 10 can validates the merchant ID by, for example, matching the merchant ID against the database maintained by the certificate system 10.

In response to the reception of the validation result from the certificate system 10, the IVR 22 determines whether the result flag is a safe or a fail (step 48). If the result flag is not a safe, the IVR 22 informs the caller that merchant ID is not valid and that the call is being made from a phone that is not listed in its system (step 50). The IVR 22 then instructs the user to call a customer service number and terminates the phone call (step 52).

On the other hand, if the result flag from the ID validation is determined to be safe, the IVR 22 instructs the caller to enter the gift certificate number listed on the certificate (step 54). The IVR 22 repeats the number entered by the caller and asks the caller to verify that it has repeated the correct number (step 56). The IVR 22 then determines whether or not the caller has verified the number repeated (step 58). If the caller does not verify the number repeated, the IVR 22 requests the caller to re-enter the gift certificate number and again repeats the entered number asking the caller for verification.

If the IVR 22 determines that the caller has verified the gift certificate number, the IVR 22 submits the gift certificate number to the certificate system 10 for validation (step 60). The IVR 22 receives the validation result from the certificate system 10 (step 62). The result from the certificate system 10 may include a one-character result and a two-character result code. The one-character result may be in the form of an S (safe) or an F (fail). The two-character result code may specify, for example, the reason for a fail result. As an example, a “01” code may be generated if the certificate number is not found in the database. Other two character codes may be generated for various other reasons, as described below.

Based on the validation result received from the certificate system 10, the IVR 22 determines whether the result is valid (step 64). To determine whether the result is valid, the IVR 22 can determine whether the result flag received from the certificate system 10 is a safe or a fail. If the result is not valid, the IVR 22 determines if a particular result code was received from the certificate system 10 (step 66). The particular result code may be, for example, a “01” code indicating that the certificate number was not found in the system.

If the result code is not a “01” code, the IVR 22 transmits a message to the caller based on the result code received from the certificate system 10 (step 68). There may be several different result codes indicating different results of the validation by the certificate system 10. The different results and corresponding codes can be determined by the certificate system with reference to the information in the database, including the parameters and conditions for the certificate with the certificate number entered by the caller. For example, if the result code was a “02,” a message indicating that the certificate has been previously redeemed is transmitted to the caller. If the result code is a “03,” a message indicating that the certificate is not valid at this merchant is transmitted. As a further example, if the result code is a “04,” a message indicating that time and date restrictions may apply is transmitted to the caller. Other result codes and messages may be used as well. In addition to transmitting the message to the caller according to the result code, the IVR 22 may instruct the caller to call a customer service number and terminate the telephone call.

If the result code is the particular result code, such as “01,” the IVR 22 determines whether this was the second failed attempt (step 70). The IVR 22 can keep track of how many attempts the caller has made during the call. If this is a second failed attempt, the IVR instructs the user to call for further assistance (step 72). The IVR 22 can also provide the user with a customer service number and terminate the phone call. If the IVR 22 determines that this is not a second failed attempt, the IVR 22 notifies the caller that the gift certificate number was not located in the system and instructs the user to re-enter the gift certificate number (step 54). Although the IVR 22 checks if this is the second failed attempt, it should be understood the IVR 22 can be configured to check after only one or after more than two failed attempts.

As shown in FIGS. 4A and 4B, if the IVR 22 determines that the validation from the certificate system 10 is valid, the IVR 22 has determined that the certificate may be used at the merchant at the present time. As a result, the IVR 22 notifies the caller of this valid status and asks whether the caller wishes to redeem the certificate at the present time (step 74). The IVR 22 then determines, based on the caller's response, whether the consumer wishes to redeem his certificate at the present time (step 76). If the response indicates that the consumer does not wish to redeem the certificate, the IVR 22 instructs the caller to call a customer service number for further assistance and terminates the phone call (step 78).

If, on the other hand, the response indicates that the consumer wishes to redeem the certificate, the IVR 22 sends a process request to the certificate system 10 (step 80). The certificate system 10 uses the process request to determine whether the certificate can be redeemed. For example, the certificate system 10 may refer to the parameters and conditions of the certificate to determine whether or not the certificate can be redeemed. The IVR 22 then receives the result of the request from the certificate system 10 (step 82). Again, the result may be in the form of a one-character result and a two-character result code. The one-character result may be in the form of an S (safe) or F (fail). The two-character result code may provide a diagnostic indicating the reason for a fail result.

Based on the redemption result from the certificate system 10, the IVR 22 determines whether the certificate may be redeemed (step 84). If it can be redeemed, the IVR 22 processes the transaction (step 86). The processing of the transaction includes updating the database in the certificate system 10 to reflect that the certificate number has been redeemed. If the certificate cannot be redeemed, the IVR 22 instructs the caller that to call for further assistance (step 88). The IVR 22 may also instructing the user to call a customer service number for assistance and terminate the phone call.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described in order to explain the principles of the invention and as practical application to enable one skilled in the art to utilize the invention in various embodiments and with various modifications are suited to the particular use contemplated. It is intended that the scope of the invention be defined by the claims appended hereto and their equivalents.

What is claimed is:

1. A method for issuing and redeeming a certificate over a network in conjunction with an interactive voice response system, comprising:
receiving information related to a certificate the user is purchasing over the network;
creating the certificate based on the received information, the certificate including the name of the merchant at which the certificate can be redeemed and a certificate identifier;
transmitting the certificate to the user over the network;
receiving a merchant identification in response to a call from a caller to the interactive voice response system to redeem the certificate;
validating that the merchant identification is valid;
instructing the interactive voice response system to request the caller to enter the certificate identifier if the merchant identification is valid;
receiving the certificate identifier entered by the caller over the network; and
validating the certificate based on the received certificate identifier.

2. A method according to claim 1, further comprising storing the certificate identifier along with at least some of the received information from the user related to the certificate in a database.

3. A method according to claim 1, wherein the transmitting includes generating a graphic file of the certificate and sending the graphic file to the user with an electronic mail message.

4. A method according to claim 1, wherein the merchant identification is an identifier associated with the merchant named in the certificate.

5. A method according to claim 1, wherein the merchant identification is a telephone number for accessing the interactive voice response system.

6. A method according to claim 5, wherein validating that the merchant identification is valid includes determining whether the telephone number is present in a database.

7. A method according to claim 1, further comprising instructing the interactive voice response system to request the caller to call a customer service number if the merchant identification is invalid.

8. A method according to claim 1, wherein the certificate identifier is entered via a touch tone pad.

9. A method according to claim 1, wherein validating that the received certificate identifier is valid includes determining whether the certificate identifier is present in a database.

10. A method according to claim 1, wherein the certificate further includes conditions for redeeming the certificate.

11. A method according to claim 10, further comprising determining whether the certificate can be redeemed based on the conditions for redeeming the certificate.

12. A method according to claim 11, further comprising storing the certificate identifier, the merchant identification and the conditions for redeeming the certificate in a database and referring to the database to determine whether the certificate can be redeemed.

13. A system for issuing and redeeming a certificate over a network in conjunction with an interactive voice response system, comprising:
means for receiving information related to a certificate the user is purchasing over the network;
means for creating the certificate based on the received information, the certificate including the name of the merchant at which the certificate can be redeemed and a certificate identifier;
means for transmitting the certificate to the user over the network;
means for receiving a merchant identification in response to a call from a caller to the interactive voice response system to redeem the certificate;
means for validating that the merchant identification is valid;
means for instructing the interactive voice response system to request the caller to enter the certificate identifier if the merchant identification is valid;
means for receiving the certificate identifier entered by the caller over the network; and
means for validating the certificate based on the received certificate identifier.

14. A system according to claim 13, further comprising means for storing the certificate identifier along with at least some of the received information from the user related to the certificate in a database.

15. A system according to claim 13, wherein said means for transmitting includes means for generating a graphic file of the certificate and sending the graphic file to the user with an electronic mail message.

16. A system according to claim 13, wherein the merchant identification is an identifier associated with the merchant named in the certificate.

17. A system according to claim 13, wherein the merchant identification is a telephone number for accessing the interactive voice response system.

18. A system according to claim 17, wherein means for validating that the merchant identification is valid includes means for determining whether the telephone number is present in a database.

19. A system according to claim 13, further comprising means for instructing the interactive voice response system to request the caller to call a customer service number if the merchant identification is invalid.

20. A system according to claim 13, wherein the certificate identifier is entered via a touch tone pad.

21. A system according to claim 13, wherein validating that the received certificate identifier is valid includes determining whether the certificate identifier is present in a database.

22. A system according to claim 13, wherein the certificate further includes conditions for redeeming the certificate.

23. A system according to claim 22, further comprising means for determining whether the certificate can be redeemed based on the conditions for redeeming the certificate.

24. A system according to claim 23, further comprising means for storing the certificate identifier, the merchant identification and the conditions for redeeming the certificate in a database and referring to the database to determine whether the certificate can be redeemed.
